(19) United States
(12) Patent Application Publication
(10) Pub. No.: US 2003/0149612 A1
(43) Pub. Date: Aug. 7, 2003

(54) Enabling a recommendation system to provide user-to-user recommendations

(75) Inventors: Frank Berghofer, Nidderau (DE); Hermann Stamm-Wilbrandt, Eberbach (DE); Lars Gendner, Berlin (DE); Michael Tsakonas, Berlin (DE)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY

(21) Appl. No.: 10/282,778

(22) Filed: Oct. 29, 2002

(30) Foreign Application Priority Data
Oct. 31, 2001 (EP) 01125975.1

(51) Int. Cl. G06F 17/60

(52) U.S. Cl. 705/10

(57) ABSTRACT

A computerized method and corresponding means for rating an item within a recommendation system. In a recommendation scheme, each of a multitude of users U and each of a multitude of items I is included in a profile P(U,I) that comprises ratings. Based on the similarity between a given user and the multitude of users in terms of the ratings, a subset of users is selected who have interest similar to those of the given user.

### FIELD OF THE INVENTION

The present invention relates to recommendation systems capable of recommending items to a given user based on item recommendations of the same given user and other users of the system. More particularly the current invention relates to an improved technology for enhancing the spectrum of possible recommendations within recommendation systems allowing these systems to provide new types of recommendations.

### BACKGROUND

A new area of technology with increasing importance is the domain “collaborative filtering” or “social filtering” of information. These technologies represent novel approaches to information filtering that do not rely on the “contents” of objects as is the case for content-based filtering. Instead, filtering relies on meta-data “about” objects. This meta data may be either collected automatically, that is data is inferred from the users' interactions with the system (for instance by the time spent reading articles as an indicator of interest), or may be voluntarily provided by the users of the system. In essence, the main idea is to automate the process of “word-of-mouth” by which people recommend products or services to one another.

If one needs to choose between a variety of options with which one does not have any experience, one will often rely on the opinions of others who do have such experience. However, when there are thousands or millions of options, like in the Web, it becomes practically impossible for an individual to locate reliable experts that can give advice about each of the options. By shifting from an individual to a collective method of recommendation, the problem becomes more manageable.

Instead of asking for the opinion of each individual, one might try to determine an “average opinion” for the group. This, however, ignores a given person's particular interests, which may be different from those of the “average person”. Therefore one would rather like to hear the opinions of those people who have interests similar to one's own, that is to say, one would prefer a “division-of-labor” type of organization, where people only contribute to the domain they are specialized in.

The basic mechanism behind collaborative filtering systems is the following:

a large group of people's preferences are registered;

using a similarity metric, a subgroup is selected whose preferences are similar to the preferences of the person who seeks advice;

a (possibly weighted) average of the preferences for that subgroup is calculated;

the resulting preference function is used to recommend options on which the advice-seeker has expressed no personal opinion yet.

Typical similarity metrics are Pearson correlation coefficients between the users' preference functions and (less frequently) vector distances or dot products. If the similarity metric has indeed selected people with similar tastes, the chances are great that the options that are highly evaluated by that group will also be appreciated by the advice-seeker.

A typical application is the recommendation of books, music CDs, or movies. More generally, the method can be used for the selection of documents, services, products of any kind, or in general any type of resource.

In the world outside the Internet, rating and recommendations are provided by services such as:

Newspapers, magazines, books, which provide ratings by their editors or publishers, who select information which they think their readers want.

Consumer organizations and trade magazines which evaluate and rate products.

Published reviews of books, music, theater, films, and so forth.

Peer review method of selecting submissions to scientific journals.

Examples for these technologies are for instance the teachings of John B. Hey, “System and method of predicting subjective reactions”, U.S. Pat. No. 4,870,579 or John B. Hey, “System and method for recommending items”, U.S. Pat. No. 4,996,642, both assigned to Neonics Inc., as well as Christopher P. Bergh, Max E. Metral, David Henry Ritter, Jonathan Ari Sheena, James J. Sullivan, “Distributed system for facilitating exchange of user information and opinion using automated collaborative filtering”, U.S. Pat. No. 6,112,186, assigned to Microsoft Corporation.

In spite all these advances and especially due to the increased importance of the Internet, which provides the access technology and communication infrastructure to recommendation systems, there is still a need in the art for improvement.

Summary

An object of the invention is to enhance the spectrum of possible recommendations within recommendation systems, allowing these systems to provide new types of recommendations.

The present invention relates to a computerized method and corresponding means for rating an item within a recommendation system.

The invention exploits a recommendation scheme wherein, for each of a multitude of users U and for each of a multitude of items I, a profile P(U,I) comprises at least a rating. By determining from the recommendation scheme a subset of the multitude of users, based on the similarity between the first user and the multitude of users, at least in terms of ratings it becomes possible to recommend the subset as the recommended users.

Thus, the current invention provides new types of recommendations, namely to identify other users to a requesting first user. The suggested technology therefore enhances the spectrum of possible recommendations within recommendation systems by allowing these systems to provide new types of recommendations. These benefits can be achieved without modifying the recommendation system itself, by structuring the recommendation scheme provided to a recommendation system as input to be processed in a novel way. These kinds of recommendations can be exploited in community or community-based systems to bring people together.

### BRIEF DESCRIPTION OF THE DRAWINGS

FIG. 1 gives an overview of recommendation systems.

FIG. 2 depicts a preferred layout of a data structure common to user profiles and item profiles according to the current invention.

FIG. 3 shows an example of the combination of user profiles and item profiles reflecting a two dimensional linkage.

FIG. 4 shows a flow diagram for a first embodiment of the inventive methodology.

FIG. 5 depicts a first example of the layout and structure of the recommendation scheme according to a first embodiment of the current invention.

FIG. 6 depicts a second example of the layout and structure of the recommendation scheme according to a second embodiment of the current invention.

FIG. 7 shows the flow diagram of another embodiment of the inventive methodology.

### DETAILED DESCRIPTION

The drawings and specification set forth a preferred embodiment of the invention. Although specific terms are used, the description thus given uses terminology in a generic and descriptive sense only, and not for purposes of limitation. It will, however, be evident that various modifications and changes may be made thereto without departing from the broader spirit and scope of the invention as set forth in the appended claims.

The present invention can be realized in hardware, software, or a combination of hardware and software. Any kind of computer system—or other apparatus adapted for carrying out the methods described herein—is suited. A typical combination of hardware and software could be a general purpose computer system with a computer program that, when being loaded and executed, controls the computer system so that it carries out the methods described herein. The present invention can also be embedded in a computer program product, which comprises all the features enabling the implementation of the methods described herein, and which—when being loaded in a computer system—is able to carry out these methods.

Computer program means or computer program in the present context mean any expression, in any language, code or notation, of a set of instructions intended to cause a system having information processing capability to perform a particular function either directly or after either or both of the following a) conversion to another language, code or notation; b) reproduction in a different material form.

As referred to in this description, items to be recommended can be objects of any type; as mentioned above, an item may refer to any type of resource one can think of.

4.1 Concepts of Recommendation Systems

The following is a short outline on the basic concepts of recommendation systems.

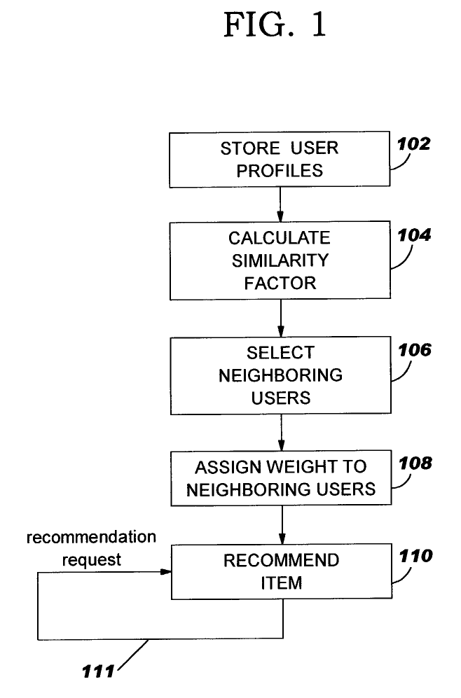

Referring now to FIG. 1, a method for recommending items begins by storing user and item information in profiles. A plurality of user profiles is stored in a memory (step 102). One profile may be created for each user or multiple profiles may be created for a user to represent that user over multiple domains. Alternatively, a user may be represented in one domain by multiple profiles where each profile represents the proclivities of a user in a given set of circumstances. For example, a user that avoids seafood restaurants on Fridays, but not on other days of the week, could have one profile representing the user's restaurant preferences from Saturday through Thursday, and a second profile representing the user's restaurant preferences on Fridays. In some embodiments, a user profile represents more than one user. For example, a profile may be created which represents a woman and her husband for the purpose of selecting movies. Using this profile allows a movie recommendation to be given which takes into account the movie tastes of both individuals.

For convenience, the remainder of this specification will use the term “user” to refer to single users of the system, as well as “composite users.” The memory can be any memory known in the art that is capable of storing user profile data and allowing the user profiles to be updated, such as disc drive or random access memory.

Each user profile associates items with the ratings given to those items by the user. Each user profile may also store information in addition to the user's rating. In one embodiment, the user profile stores information about the user, e.g. name, address, or age. In another embodiment, the user profile stores information about the rating, such as the time and date the user entered the rating for the item. User profiles can be any data construct that facilitates these associations, such as an array, although it is preferred to provide user profiles as sparse vectors of n-tuples. Each n-tuple contains at least an identifier representing the rated item and an identifier representing the rating that the user gave to the item, and may include any number of additional pieces of information regarding the item, the rating, or both. Some of the additional pieces of information stored in a user profile may be calculated based on other information in the profile. For example, an average rating for a particular selection of items (e.g., heavy metal albums) may be calculated and stored in the user's profile. In some embodiments, the profiles are provided as ordered n-tuples.

Whenever a user profile is created, a number of initial ratings for items may be solicited from the user. This can be done by providing the user with a particular set of items to rate corresponding to a particular group of items. Groups are genres of items and are discussed below in more detail. Other methods of soliciting ratings from the user may include: manual entry of item-rating pairs, in which the user simply submits a list of items and ratings assigned to those items; soliciting ratings by date of entry into the system, i.e., asking the user to rate the newest items added to the system; soliciting ratings for the items having the most ratings; or by allowing a user to rate items similar to an initial item selected by the user.

In still other embodiments, the system may acquire a number of ratings by monitoring the user's environment. For example, the system may assume that Web sites for which the user has created “bookmarks” are liked by that user and may use those sites as initial entries in the user's profile. One embodiment uses all of the methods described above and allows the user to select the particular method they wish to employ.

Ratings for items which are received from users can be of any form that allows users to record subjective impressions of items based on their experience of the item. For example, items may be rated on an alphabetic scale (“A” to “F”) or a numerical scale (1 to 10). In one embodiment, ratings are integers between 1 (lowest) and 7 (highest).

Any technology may be exploited to input these ratings into a computer system. Ratings even can be inferred by the system from the user's usage pattern. For example, the system may monitor how long the user views a particular Web page and store in that user's profile an indication that the user likes the page, assuming that the longer the user views the page, the more the user likes the page. Alternatively, a system may monitor the user's actions to determine a rating of a particular item for the user. For example, the system may infer that a user likes an item which the user mails to many people, and enter in the user's profile an indication that the user likes that item. More than one aspect of user behavior may be monitored in order to infer ratings for that user, and in some embodiments, the system may have a higher confidence factor for a rating which it inferred by monitoring multiple aspects of user behavior. Confidence factors are discussed in more detail below.

Profiles for each item that has been rated by at least one user may also be stored in memory. Each item profile records how particular users have rated this particular item. Any data construct that associates ratings given to the item with the user assigning the rating can be used. It is preferable to provide item profiles as a sparse vector of n-tuples. Each n-tuple contains at least an identifier representing a particular user and an identifier representing the rating that user gave to the item, and may contain other information as well, as described above in connection with user profiles.

The additional information associated with each item-rating pair can be used by the system for a variety of purposes, such as assessing the validity of the rating data. For example, if the system records the time and date the rating was entered, or inferred from the user's environment, it can determine the age of a rating for an item. A rating which is very old may indicate that the rating is less valid than a rating entered recently. For example, users' tastes may change or “drift” over time. One of the fields of the n-tuple may represent whether the rating was entered by the user or inferred by the system. Ratings that are inferred by the system may be assumed to be less valid than ratings that are actually entered by the user. Other items of information may be stored, and any combination or subset of additional information may be used to assess rating validity. In some embodiments, this validity metric may be represented as a confidence factor, that is, the combined effect of the selected pieces of information recorded in the n-tuple may be quantified as a number. In some embodiments, that number may be expressed as a percentage representing the probability that the associated rating is incorrect or as an expected deviation of the predicted rating from the “correct” value.

The user profiles are accessed in order to calculate a similarity factor for each given user with respect to all other users (step 104). A similarity factor represents the degree of correlation between any two users with respect to the set of items. The calculation to be performed may be selected such that the more two users correlate, the closer the similarity factor is to zero.

Whenever a rating is received from a user or is inferred by the system from that user's behavior, the profile of that user may be updated as well as the profile of the item rated. Profile updates may be stored in a temporary memory location and entered at a convenient time, or profiles may be updated whenever a new rating is entered by or inferred for that user. Profiles can be updated by appending a new n-tuple of values to the set of already existing n-tuples in the profile or, if the new rating is a change to an existing rating, overwriting the appropriate entry in the user profile. Updating a profile also requires re-computation of any profile entries that are based on other information in the profile. Especially whenever a user's profile is updated with new rating-item n-tuple, new similarity factors between the user and other users of this system should be calculated. In other embodiments, similarity factors are periodically recalculated, or recalculated in response to some other stimulus, such as a change in a neighboring user's profile. The similarity factors for a user are calculated by comparing that user's profile with the profile of every other user of the system. This is computationally intensive, since the order of computation for calculating similarity factors in this manner is n², where n is the number of users of the system. It is possible to reduce the computational load associated with recalculating similarity factors in embodiments that store item profiles by first retrieving the profiles of the newly-rated item and determining which other users have already rated that item. The similarity factors between the newly-rating user and the users that have already rated the item are the only similarity factors updated. In general, a method for calculating similarity factors between users should minimize the deviation between a predicted rating for an item and the rating a user would actually have given the item.

A similarity factor between users refers to any quantity which expresses the degree of correlation between two user's profiles for a particular set of items. The following methods for calculating the similarity factor are intended to be exemplary, and in no way exhaustive. Depending on the item domain, different methods will produce optimal results, since users in different domains may have different expectations for rating accuracy or speed of recommendations. Different methods may be used in a single domain, and, in some embodiments, the system allows users to select the method by which they want their similarity factors produced.

In the following description of methods, D_{xy} represents the similarity factor calculated between two users, x and y. Hᵢₓ represents the rating given to item i by user x, I represents all items in the database, and Cᵢₓ is a Boolean quantity which is 1 if user x has rated item i and 0 if user x has not rated that item.

One method of calculating the similarity between a pair of users is to calculate the average squared difference between their ratings for mutually rated items. Thus, the similarity factor between user x and user y is calculated by subtracting, for each item rated by both users, the rating given to an item by user y from the rating given to that same item by user x and squaring the difference. The squared differences are summed and divided by the total number of items rated. This method is represented mathematically by the following expression:

$${D}_{xy} = \frac{{\sum }_{i ∈ I} {( {c}_{ix} ( {c}_{iy} ( {H}_{ix} - {H}_{iy} ) ) )}^{2}}{{\sum }_{i ∈ I} {c}_{ix} {c}_{iy}}$$

A similar method of calculating the similarity factor between a pair of users is to divide the sum of their squared rating differences by the number of items rated by both users raised to a power. This method is represented by the following mathematical expression:

$${D}_{xy} = \frac{{\sum }_{i ∈ {C}_{xy}} {( {H}_{ix} - {H}_{iy} )}^{2}}{\vert {C}_{xy} {\vert}^{k}}$$

where |C_{xy}| represents the number of items rated by both users.

A third method for calculating the similarity factor between users factors into the calculation the degree of profile overlap, i.e. the number of items rated by both users compared with the total number of items rated by either one user or the other. Thus, for each item rated by both users, the rating given to an item by user y is subtracted from the rating given to that same item by user x. These differences are squared and then summed. The amount of profile overlap is taken into account by dividing the sum of squared rating differences by the number of items mutually rated by the users subtracted from the sum of the number of items rated by user x and the number of items rated by users y. This method is expressed mathematically by:

$${D}_{xy} = \frac{{\sum }_{i ∈ Cxy} {( {H}_{ix} - {H}_{iy} )}^{2}}{{\sum }_{i ∈ I} {c}_{ix} + {\sum }_{i ∈ I} {c}_{iy} - \vert {C}_{xy} \vert}$$

where |C_{xy}| represents the number of items mutually rated by users x and y.

In another embodiment, the similarity factor between two users is a Pearson r correlation coefficient. Alternatively, the similarity factor may be calculated by constraining the correlation coefficient with a predetermined average rating value, A. Using the constrained method, the correlation coefficient, which represents D_{xy}, is arrived at in the following manner. For each item rated by both users, A is subtracted from the rating given to the item by user x and the rating given to that same item by user y. Those differences are then multiplied. The summed product of rating differences is divided by the product of two sums. The first sum is the sum of the squared differences of the predefined average rating value, A, and the rating given to each item by user x. The second sum is the sum of the squared differences of the predefined average value, A, and the rating given to each item by user y. This method is expressed mathematically by:

$${D}_{xy} = \frac{{\sum }_{i ∈ Cxy} ( {H}_{ix} - A ) ( {H}_{iy} - A )}{{\sum }_{i ∈ Ux} {( {H}_{ix} - A )}^{2} + {\sum }_{i ∈ Uy} {( {H}_{iy} - A )}^{2}}$$

where Uₓ represents all items rated by x, U_{y} represents all items rated by y, and C_{xy} represents all items rated by both x and y. The additional information included in a n-tuple may also be used when calculating the similarity factor between two users. For example, the information may be considered separately in order to distinguish between users, e.g. if a user tends to rate items only at night and another user tends to rate items only during the day, the users may be considered dissimilar to some degree, regardless of the fact that they may have rated an identical set of items identically.

Regardless of the method used to generate them, or whether the additional information contained in the profiles is used, the similarity factors are used to select a plurality of users that have a high degree of correlation to a user (step 106). These users are called the user's “neighboring users.” A user may be selected as a neighboring user if that user's similarity factor with respect to the requesting user is better than a predetermined threshold value, L. The threshold value, L, can be set to any value which improves the predictive capability of the method. In general, the value of L may change depending on the method used to calculate the similarity factors, the item domain, and the size of the number of ratings that have been entered. In another embodiment, a predetermined number of users are selected from the users having a similarity factor better than L, e.g. the top twenty-five users. For embodiments in which confidence factors are calculated for each user-user similarity factor, the neighboring users can be selected based on having both a threshold value less than L and a confidence factor higher than a second predetermined threshold.

A user's neighboring user set should be updated each time that a new rating is entered by, or inferred for, that user. This requires determination of the identity of the neighboring users as well as all the similarity factors between this given user and its neighboring users. Moreover, due to the update of a certain rating of a first user the set of neighboring users of a multitude of other users should be changed. For instance this first user may need to be introduced or removed as a member of the set of neighboring users of other users, in which case the involved similarity factors should be re-computed.

With increasing numbers of users and increased exploitations of recommendation systems, this need for continuous recomputation of precomputed neighboring users and their similarity factors becomes a real processing burden for such systems. Thus in many applications it is desirable to reduce the amount of computation required to maintain the appropriate set of neighboring users by limiting the number of user profiles consulted to create the set of neighboring users. In one embodiment, instead of updating the similarity factors between a rating user and every other user of the system (which has computational order of n²), only the similarity factors between the rating user and the rating user's neighbors, as well as the similarity factors between the rating user and the neighbors of the rating user's neighbors are updated. This limits the number of user profiles which must be compared to m² minus any degree of user overlap between the neighbor sets where m is a number smaller than n.

Once a set of neighboring users is chosen, a weight is assigned to each of the neighboring users (step 108). In one embodiment, the weights are assigned by subtracting the similarity factor calculated for each neighboring user from the threshold value and dividing by the threshold value. This provides a user weight that is higher, i.e. closer to one, when the similarity factor between two users is smaller. Thus, similar users are weighted more heavily than other, less similar, users. In other embodiments, the confidence factor can be used as the weight for the neighboring users. Of course many other approaches may be chosen to assign weights to neighboring users based on the calculated similarity factors.

Once weights are assigned to the neighboring users, an item is recommended to a user (step 110). For applications in which positive item recommendations are desired, items are recommended if the user's neighboring users have also rated the item highly. For an application desiring to warn users away from items, items are displayed as recommended against when the user's neighboring users have also given poor ratings to the item.

As indicated above, recommendation systems servicing a large number of users with a high-frequency of updating their rating values create a significant computation burden for the allocation of the precomputed similarity factors and neighboring users. Within the state of the art it is thus suggested that the similarity factors are recalculated periodically only, or are recalculated only in response to some other stimulus. This approach is reflected within FIG. 1, which shows that the steps 102 up to 110 to calculate the precomputed neighboring users (comprising similarity factors, weights and the neighboring users themselves) are performed only once (or at least with a low frequency) and provide a static basis for processing a huge multitude of individual recommendation requests within step 111.

Efficiency is important in generating matchings and/or recommendations. Efficiency will be experienced by a user in terms of the system's latency, i.e. the time required to process time of a user's recommendation request. From the perspective of recommendation systems themselves the efficiency aspect is related to the frequency in which recommendation requests are entered into recommendation systems for processing. For online businesses, latency in the sub-second area is a must.

In European patent application number 01111407.1 to IBM as applicant, another type of recommendation system is disclosed which avoids the requirement of creation and maintenance of static, precomputed similarity factors stored persistently. This teaching suggests computing, on a temporary basis only, for each individual recommendation request of a given user, the similarity factors measuring the similarity between the given user and the multitude of users. Such techniques may be applied to the current invention as well, as the current invention is independent from the specific technique of how and when similarity factors are calculated.

One example of a potentially more detailed structure of the various profiles (user profiles, item profiles) is discussed next. In this example embodiment, the combination of user profiles and item profiles includes a multitude of identical data structures each comprising at least a user identification, an item identification, and a corresponding rating value (potentially enhanced with computed similarity factors). For efficient use of the computer's memory, this common data structure should be limited in size.

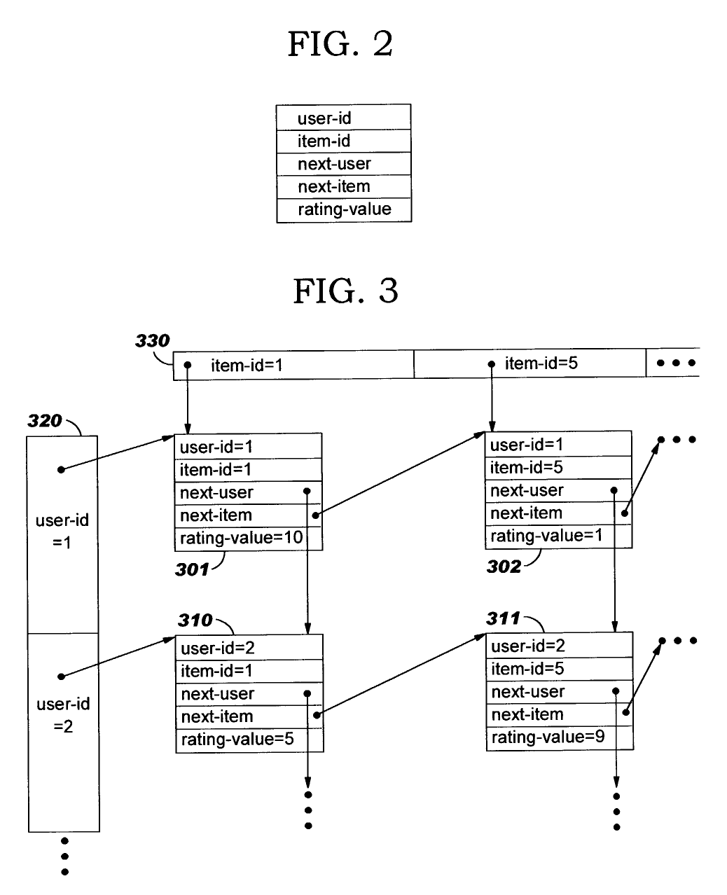

A potential layout of this data structure common to user profiles and item profiles is depicted in FIG. 2. Each rating or nonnull matrix entry is represented by a tuple comprising as least the following data elements:

user-id: identification of a certain user

item-id: identification of a certain item

Next-user: a link to an identical data structure characterizing the next user in a sequence according the user-ids

Next-item: a link to an identical data structure characterizing the next item in a sequence according the item-ids

rating value: the rating value of the item characterized by an item-id provided by a user characterized by a user-id.

Of course this list may be enhanced by similarity factors computed by comparing the ratings of the various users.

To allow these data structures to be easily searched by the computer system, they are linked in two dimensions, resulting in a matrix-like structure. FIG. 3 shows an example of the combination of user profiles and item profiles reflecting the two dimensional linkage. The first dimension 320 links all data structures with the same user identification in a sequence according to the item identifications (user profile). The second dimension 330 links all data structures with the same item identification in a sequence according to the user identifications (item profile). Referring to FIG. 3 examples of the basic data structure are depicted by 301, 302, 310, 311. In the horizontal dimension these elementary data structures are linked thus, that each row represents the user profile. In the vertical dimension these elementary data structures are all linked thus, so that each column represents one item profile.

Fundamental Observations

The following observations provide a deeper insight into the problems with the state of the art. These observations further reveal the cause for these problems and in a step by step process explain the solution proposed by the current invention.

From the preceding description it follows that recommendation systems exploit recommendation schemes wherein, for each of a multitude of users U and for each of a multitude of items I, a profile P(U,I) comprises at least a rating (refer for instance to FIG. 3). Therefore, the recommendation scheme can be viewed as a matrix P(U,I).

A serious deficiency of the state of the art for collaborative filtering recommendation systems is that, although items can represent objects of any type, the state of the art does not allow suggesting, to a first user, a multitude of other users (which will be called throughout the current specification user-to-user recommendation). The current invention enhances the recommendation technology by supporting user-to-user recommendations. These kinds of recommendations may be exploited in communities or community-based systems to bring people together. The current invention provides mechanisms for recommendations of one or a multitude of users to a given user, utilizing collaborative filtering technology. With the current state of the art technology, only items can be recommended to users, but not users to other users.

According to the invention, this can be achieved by determining from the recommendation scheme a subset of the multitude of users of the recommendation system, based on the similarity between a first user and the multitude of users at least in terms of the ratings. That subset is recommended to the first user.

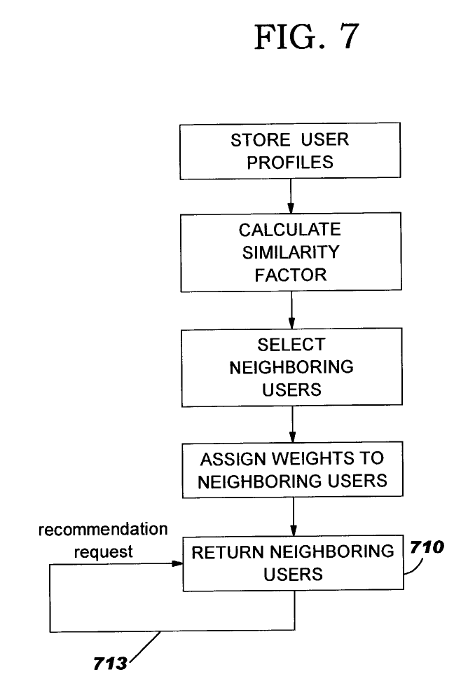

This basic idea is shown in FIG. 7 which illustrates the difference with respect to the state of the art situation depicted in FIG. 1. According to this idea the specific subset of users to be recommended to the first user consists of the neighboring users of the first user, as determined by similarity based on items rated by these users. An important difference to the flowchart of FIG. 1 appears in step 710, wherein the neighboring users are returned directly to a requesting first user, instead of items normally returned.

In order to be able to recommend a user U to a certain user, there must exist a user-valued item I_{U} that reflects the user U as an item in the recommendation scheme (in other words, representing the user as some type of “artifical item”). Additionally at least one rating must exist for the user-valued item I_{U}, since only items being rated may be recommended. Therefore, according to the invention each user U rates its corresponding user-valued item I_{U} by some predefined rating value S, thereby enabling U to recommend “himself” by recommending I_{U}, if selected as neighbor for some other user. According to this approach, the diagonal matrix elements P(U,I_{U}) within the recommendation scheme are set to a predefined value S.

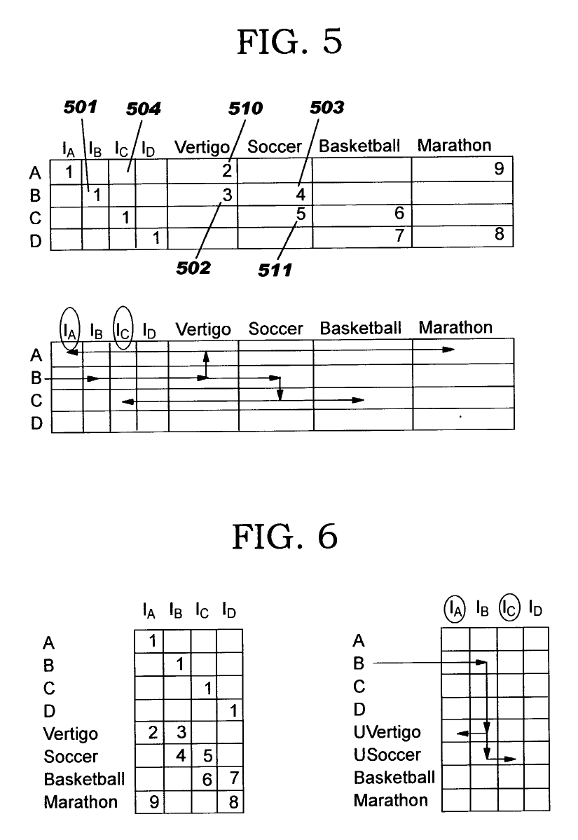

This enhanced structure of the recommendation scheme is shown in FIG. 5. The vertical dimension of this matrix denotes the individual users; in this case the users A to D. The horizontal dimension designates the individual items within the recommendation scheme. The new user-valued items are reflected as the items I_{A} to I_{D} within this figure. Moreover the diagonal matrix elements set to a constant value S=1 are depicted; refer for instance to 501.

A First Embodiment of the Current Invention

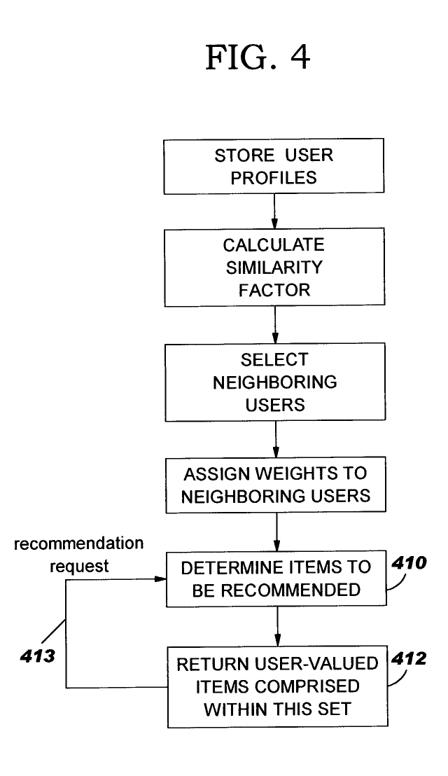

In a first embodiment the recommendation of users is achieved by changing the recommendation method as already discussed in the flowchart of FIG. 1. Refer to FIG. 4 for this new approach. Step 110 according to the state of the art is replaced according to the invention by two new steps, step 410 and step 412. In step 410 the recommended set of items is determined. Due to the specifically enhanced structure of the recommendation scheme, this set of recommended items also comprises user-valued items. Thus, it is possible to let step 412 select the user-valued items from this set and let this step return these users as the resulting set of recommended users. Since user-valued items correspond to the users in a one-to-one fashion this recommendation scheme really recommends one or a multitude of users to a first requesting user.

Therefore, based on the nature of the above introduced enhanced recommendation scheme, the methodology to suggest users to a first requesting user traverses the following steps:

A step (A) of determining from the recommendation scheme a subset of the multitude of users as neighboring users N of the first user. This determination is based on the similarity between the first user and the multitude of users at least in terms of the ratings these users provided to the system.

A step (B) of determining from the recommendation scheme as recommended items one or a multitude of items again based on the similarity with the neighboring users N and based on the rating of the items of the neighboring users N.

A step (C) of recommending user-valued items comprised within the recommended items (determined in step B) as the recommended users.

The simple example of FIG. 5 illustrates the above teaching of the first embodiment. As shown in FIG. 5, user B has rated three items, one user-valued item I_{B} 501 (actually representing himself), and two “normal” items, <Vertigo>502 and <Soccer>503. Due to the special rating of users and their corresponding user-valued items, the neighboring users are determined only on the basis of ratings of non user-valued items. In this simple example the neighbors of B are A and C. The reasons for this are twofold: first, the rating vectors of B and D are orthogonal; second, the rating vectors of A and B show an overlap in profiles 510 and 502 and the rating vectors of users B and C show an overlap in profiles 503 and 511. Thus, the total set of items determined in step 410 is

{I_{A}, <Marathon >,I_{C},<Basketball >}

Finally step 412 returns the user-valued items of this set only, i.e. {I_{A},I_{C}}. Therefore the users A and C are recommended to user B in this user-to-user recommendation.

The arrows in the lower part of FIG. 5 show how the recommended items for the requesting user B can be determined. The procedure starts along the horizontal arrows relating to user B by determining all nonzero rating values. Once these are known, examining the recommendation scheme in the vertical direction of these nonzero rating values allows determination of other users, also providing nonzero rating values for these items. These users define the neighboring users of user B. In the next step these neighboring users are analyzed in the horizontal dimension of the recommendation scheme to determine those rated items which have not been rated by the first user B. The union of these items represents the candidate items set for the recommendation.

A Second Embodiment of the Current Invention

In a second embodiment, objects to be rated by the users are no longer represented as items within the recommendation scheme. The only items in this embodiment are the user-valued items as outlined in the first embodiment above. On the other hand the objects to be rated have to be represented somehow. For that purpose, the recommendation scheme comprises, for each object I which can be rated by the multitude of users, an item-valued user U_{I}. The item-valued user represents the object as a user within the recommendation scheme (representing an item as a kind of “artificial user”). For each rating of a user U for an object I, at runtime this rating is now stored in profile P(U_{I},I_{U}) (no longer in profile P(U,I) which does not exist in this embodiment). The recommended items are user-valued items exclusively, and as per construction objects to be rated, they are not represented as items but as item-valued users only. Since user-valued items correspond to the users in a one-to-one fashion this recommendation scheme actually recommends one or a multitude of users to a given user.

FIG. 6 illustrates an example of this second embodiment. User B has rated three items, one user-valued item I_{B}, and two “normal” items, <Vertigo>and <Soccer>, represented as item-valued users. Because of the special treatment of users and their corresponding item-valued users, the neighboring users are determined as a subset of the user-valued items a first requesting user has rated already. Because the rating vectors in P(U,I) for users A to D are orthogonal they are treated as “not similar”. Therefore the neighborhood of user B is built by the item-valued users <Vertigo>and <Soccer>. Finally the recommended item of item-valued user <Vertigo>is I_{A} and that of item-valued user <Soccer>is I_{C}. Therefore the users A and C are recommended to user B as user-to-user recommendation.

The arrows in the lower part of FIG. 6 show how the recommended items (in this case user-valued items only) for the requesting user B can be determined. The procedure starts along the vertical arrow relating to user B by determining all nonzero rating values. Once these are known, examining the recommendation scheme in the horizontal direction of these nonzero rating values allows determination of other users, also providing nonzero rating values for these items. These users define the neighboring users of user B. In the next step these neighboring users (item-valued users) are analyzed in the horizontal dimension of the recommendation scheme to determine those rated items which have not been rated by the first user B. The union of these items represents the candidate items set (user-valued items) for the recommendation.

A Third Embodiment of the Current Invention

A third embodiment uses relationships between users for generating recommendations. Both previous embodiments comprise user-valued items, but so far only ratings on the main diagonal of the square submatrix consisting of the users and user-valued items have been considered. The idea here is to use the off-diagonal entries (refer for instance to 504, 601) in this square submatrix for user-to-user ratings. The possibility that a first user might rate a second user is opened by reliance upon the fundamental idea of the current invention to model users also as items, the so called user-valued items.

Examples of these kinds of ratings are activities of a given user U in a community platform:

user U opens the homepage of another user U′

user U sends user U′ an email

user U puts user U′ on his ignore-list

These actions may be recognized in the recommendation system by storing appropriate values in the profile P(U,U′). Here the rating could be slightly positive in the first case, positive in the second and negative in the third case.

We claim:

1. A computerized method for recommending to a first user a set of recommended users, said method exploiting a recommendation scheme wherein for each of a pluralty of users U and for each of a multitude of items I a profile P(U,I) comprises at least a rating value, and said recommendation scheme comprising for each of said users U also a user-valued item I_{U}, each profile P(U,I_{U}) corresponding to a user U and its corresponding user-valued item I_{U} having a predefined rating value S, said method comprising the steps of:
determining from said recommendation scheme a subset of said pluralty of users as neighboring users N of said first user based on similarity between said first user and said plurality of users in terms of said ratings;
determining from said recommendation scheme as recommended items at least one item based on the similarity with said neighboring users N and based on the rating of the items of said neighboring users N; and
recommending user-valued items included in said recommended items as said recommended users.

2. The computerized method for recommending according to claim 1, wherein said recommendation scheme includes, for each object which can be rated by said users, an item.

3. The computerized method for recommending according to claim 1, wherein
said recommendation scheme includes, for each object which can be rated by said multitude of users, an item-valued user U_{I}, said item-valued user reflecting said object as a user within said multitude of users U; and
said recommendation scheme includes a rating of at least a user U for an object, said object being reflected as item-valued user U_{I}, and said rating being included within a profile P(U_{I},I_{U}), said profile corresponding to said item-valued user U_{I} and to said user-valued item I_{U} of said user U.

4. The computerized method for recommending according to claim 3, wherein said recommendation scheme includes a rating of at least a second user U2 of a third user U3 within a profile P(U2,I_{U3}), said profile corresponding to said second user U2 and a user-valued item I_{U3} corresponding to said third user U3.

5. A data processing program for execution in a data processing system comprising software code portions for performing a method according to claim 1 when said program is run on said computer.

6. A computer program product stored on a computer usable medium, comprising computer readable program means for causing a computer to perform a method according to claim 1 when said program is run on said computer.
